(19) United States
(12) Patent Application Publication
(10) Pub. No.: US 2009/0273655 A1
(43) Pub. Date: Nov. 5, 2009

(54) INK RESERVOIR FOR INKJET PRINT SYSTEM

(75) Inventors: Jin-Cheol Song, Seoul (KR); Tae-Keun Park, Seoul (KR); Choong-Ho Lee, Euiwang-si (KR); Sang-Yup Yu, Siheung-Si (KR)

Correspondence Address: CANTOR COLBURN, LLP, 20 Church Street, 22nd Floor, Hartford, CT, 06103, US

(73) Assignee: SJ-D5 INC., Seoul (KR)

(21) Appl. No.: 11/720,959

(22) PCT Filed: Jun. 14, 2005
(86) PCT No.: PCT/KR2005/001810

§ 371 Date: Jun. 6, 2007

(30) Foreign Application Priority Data
Dec. 29, 2004 (KR) 2020040037255
May 24, 2005 (KR) 2020050014689

(51) Int. Cl. B41J 2/175

(52) U.S. Cl. 347/86

(57) ABSTRACT

A replaceable ink reservoir adapted to an inkjet print system is provided. Since the inkjet print system of the conventional arts drives an air pump to inject air into the ink reservoir to discharge the ink stored in the ink storage pack to a printer cartridge, serious noise may be generated when the air pump is driven. In addition, in order to discharge the ink through the injection of the air, the ink reservoir should be one integrated body having a hermetically sealed structure, therefore, a user cannot visually check an ink storage level in the ink storage pack from the exterior of the ink reservoir. Further, since a nozzle connecting pipe is always connected to an ink outlet port connected to a front end of the ink storage pack, it is difficult to uniformly maintain discharge pressure of the ink, thereby causing an error image to be formed on a recording medium. Therefore, the present invention provides an ink reservoir for an inkjet print system, which is visually checkable an ink discharge amount in an ink storage pack and refilling the ink in the ink storage pack received in the ink reservoir by constituting the ink reservoir using transparent assemblies, discharges the ink in the ink storage pack received in the ink reservoir using inherent expansion of an expansion member, and includes a dual safety device and a dual cover installed at front ends of the ink storage pack and the ink outlet port to block ink discharged from the ink storage pack when a print operation is completed, thereby preventing unnecessary consumption of the ink.

### TECHNICAL FIELD

The present invention relates to a replaceable ink reservoir adapted to an inkjet print system.

### BACKGROUND ART

Inkjet printing technology has been relatively well developed, and a commercial device such as a computer printer, a graphic plotter, a facsimile, and so on, is used to employ the inkjet technology for printing an image on a recording medium.

An inkjet image is formed by ejecting ink stored in an ink storage pack in an ink reservoir using an ink drop generator such as an inkjet print head, which is disclosed in U.S. patent Ser. Nos. 8/869,122 (hereinafter, referred to as conventional art 1) and 8/871,566 (hereinafter, referred to as conventional art 2), which are filed on Jun. 4, 1997, and 9/034,719 (hereinafter, referred to as conventional art 3), filed on Mar. 4, 1998.

That is, as shown in FIG. 1 illustrating the conventional art 1, a conventional inkjet print system includes an ink reservoir 1, an ink storage pack 2 disposed in the ink reservoir 1 to store ink, an air pump 3 for injecting air in an empty space A in the ink reservoir 1 to compress the ink storage pack 2, and a printer cartridge 4 for receiving the ink supplied from the ink storage pack 2.

At this time, in most cases of the conventional arts 1, 2 and 3, in order to restrict the amount of the air injected into the empty space A of the ink reservoir 1, an error message is not indicated even though the air pump 3 is not driven.

However, since the inkjet print system of the conventional arts drives the air pump 3 to inject air into the ink reservoir 1 to discharge the ink stored in the ink storage pack 2 to the printer cartridge 4, serious noise may be generated when the air pump 3 is driven.

In addition, in order to discharge the ink through the injection of the air, the ink reservoir 1 should be one integrated body having a hermetically sealed structure, therefore, a user cannot visually check an ink storage level in the ink storage pack from the exterior of the ink reservoir 1.

Further, since a nozzle connecting pipe is always connected to an ink outlet port connected to a front end of the ink storage pack 2, it is difficult to uniformly maintain the discharge pressure of the ink.

That is, when the ink is discharged into the printer cartridge 4 through the nozzle connecting pipe connected to the ink outlet port by air pressure generated on initial driving, the initial ink discharge pressure should be rapidly increased to cause an error image to be formed on a recording medium.

### DESCRIPTION OF DRAWINGS

These and/or other aspects and advantages of the present invention will become apparent and more readily appreciated from the following description of the embodiments, taken in conjunction with the accompanying drawings of which:

FIG. 1 is a schematic view illustrating an ink discharging process of a conventional inkjet print system;

FIG. 2 is a perspective view of a first ink reservoir according to an embodiment of the present invention;

FIG. 3 is a perspective view of a second ink reservoir according to an embodiment of the present invention;

FIG. 4 is a perspective view of assembled first and second ink reservoirs, into which an ink storage pack and an expansion member are inserted;

FIG. 5 is a cross-sectional view taken along the line A-A in FIG. 4;

FIG. 6 is a perspective view of a front-end cover according to an embodiment of the present invention;

FIG. 7 is a perspective view of a rear-end cover according to an embodiment of the present invention;

FIG. 8 is an assembled perspective view of an ink reservoir according to an embodiment of the present invention;

FIG. 9 is an assembled cross-sectional view of an ink reservoir according to an embodiment of the present invention;

FIG. 10 is a cross-sectional view illustrating an ink nozzle pipe inserted into an ink outlet port according to an embodiment of the present invention;

FIG. 11 is a cross-sectional view illustrating an ink nozzle pipe separated from an ink outlet port according to an embodiment of the present invention;

FIG. 12 is a cross-sectional view illustrating an ink nozzle pipe inserted into an air inlet port according to an embodiment of the present invention;

FIG. 13 is an assembled perspective view of an inkjet print system engaged with an ink reservoir according to an embodiment of the present invention;

FIG. 14 is an exploded perspective view of a cover having a dual structure of another embodiment of the present invention;

FIG. 15 is an assembled cross-sectional view of a cover having a dual structure according to another embodiment of the present invention;

FIG. 16 is a plan view of a main cover according to another embodiment of the present invention;

FIG. 17 is a cross-sectional view taken along the line B-B of FIG. 14;

FIG. 18 is an enlarged cross-sectional view illustrating a cover connected to a nozzle connecting pipe according to another embodiment of the present invention; and

FIG. 19 is an enlarged cross-sectional view illustrating a cover separated from a nozzle connecting pipe according to another embodiment of the present invention.

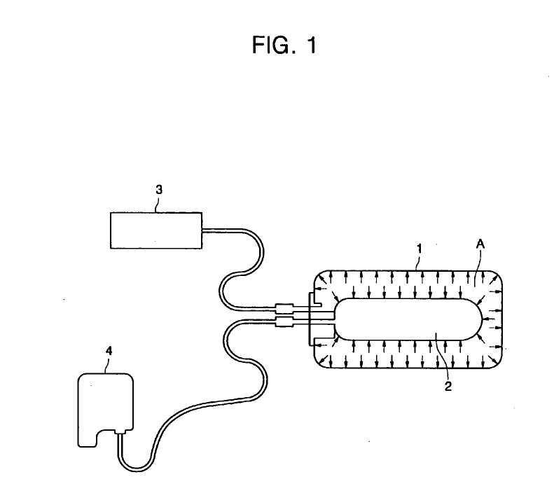

### DISCLOSURE

### [Technical Problem]

In order to solve the foregoing and/or other problems, it is an aspect of the present invention to provide an ink reservoir for an inkjet print system capable of visually checking an ink discharge amount in an ink storage pack and refilling ink in the ink storage pack received in the ink reservoir by constituting the ink reservoir using transparent assemblies.

It is another aspect of the present invention to provide an ink reservoir for an inkjet print system capable of discharging ink in an ink storage pack received in the ink reservoir using inherent expansion of an expansion member.

It is still another aspect of the present invention to provide an ink reservoir for an inkjet print system including a dual safety device installed at a front end of an ink storage pack to block the ink discharged from the ink storage pack when a print operation is completed, thereby preventing unnecessary consumption of the ink.

It is yet another aspect of the present invention to provide an ink reservoir for an inkjet print system, which can prevent the leakage of ink stored in the ink storage pack when an ink nozzle pipe is separated from the cover after the ink in the ink storage pack is discharged through the ink nozzle pipe by installing a dual cover made of two materials having different elastic recovering forces at an ink outlet port, thereby preventing unnecessary consumption of the ink.

### [Technical Solution]

The foregoing and/or other aspects of the present invention may be achieved by providing an ink reservoir for an inkjet print system including: a chassis member including an ink outlet port, an air inlet port, and an ink level detection circuit; an ink storage pack hermetically connected to a front end of the chassis member to store a predetermined amount of ink; first and second reservoirs having upper and lower openings and assembled together to form a space for receiving the ink storage pack; a front-end cover assembled at front ends of the first and second reservoirs by a fastening member when the reservoirs are assembled together; and a rear-end cover engaged with rear ends of the first and second reservoirs in a fitting manner when the reservoirs are assembled together.

In addition, the ink outlet port may include: a first packing part having a nozzle insertion port, and a first ink discharge port in fluid communication with the ink storage pack, which are respectively formed at upper and lower ends thereof; and a dual safety device installed between the first packing part and the first ink discharge port to control discharge of the ink in the ink storage pack depending on whether an ink nozzle pipe adapted to the inkjet print system is inserted into the nozzle insertion port.

Further, the dual safety device may include: a spherical member disposed under the first packing part to be movable downward when the ink nozzle pipe is inserted into the nozzle insertion port; a rod integrally formed with the spherical member and having a second ink discharge port formed at a peripheral surface of a lower end thereof; a diaphragm integrally formed with an end of the rod to control discharge of ink by opening/closing the first ink discharge port of the ink outlet port using movement of the spherical member; and a spring inserted onto the rod to return the spherical member to its original position when the ink nozzle pipe is separated from the nozzle insertion port.

The air inlet port may include a second packing part having a second nozzle insertion port for blocking air leaked to the exterior when an air nozzle pipe is inserted into a sealed space to allow the air to be introduced into the sealed space.

Further, ink in the ink storage pack may be naturally discharged by expansion of the expansion members received in the first and second reservoirs, respectively.

The expansion member may be formed of a synthetic foam material such as a sponge with open cells and sufficient flexibility and elasticity.

In addition, the expansion member may be formed of a leaf spring having sufficient flexibility and elasticity.

One of the first and second reservoirs may have an air hole for introducing an exterior air into the reservoirs to cause a space between the reservoirs to be not hermetically sealed when the ink storage pack is received in the reservoirs.

In addition, the first reservoir may include: a plurality of hooks formed at both sides thereof to be assembled with the second reservoir; a first fastening boss formed at a front end thereof to be assembled with the front-end cover; and a first projection formed at a rear end thereof to be assembled with the rear-end cover.

Further, the second reservoir may include: a plurality of fastening holes corresponding to the hooks and formed at both sides thereof to be assembled with the first reservoir; a second fastening boss formed at a front end thereof to be assembled with the front-end cover; and a second projection formed at a rear end thereof to be assembled with the rear-end cover.

The front-end cover may have fastening holes for passing through a plurality of fastening members such as bolts to be fastened to the first and second fastening bosses of the first and second reservoirs.

In addition, the rear-end cover may have hooking holes for hooking the first and second projections formed at the rear ends of the first and second reservoirs; and a see-through hole for visually checking variations of volume of the ink storage pack received in the space provided between the first and second reservoirs.

Another aspect of the present invention may be achieved by providing an ink reservoir for an inkjet print system including: a chassis member including an ink outlet port, an air inlet port, and an ink level detection circuit; an ink storage pack hermetically connected to a front end of the chassis member to store a predetermined amount of ink; first and second reservoirs having upper and lower openings and assembled together to form a space for receiving the ink storage pack; a front-end cover assembled at front ends of the first and second reservoirs by a fastening member when the reservoirs are assembled together; a rear-end cover engaged with rear ends of the first and second reservoirs in a fitting manner when the reservoirs are assembled together; and a dual cover engaged with an opening formed at a front end of the ink outlet port.

The dual cover may include a main cover fitted into the ink outlet port through the opening to prevent leakage of ink; and an auxiliary cover for sealing the opening of the ink outlet port.

In addition, the main cover and the auxiliary cover may be made of a rubber material having an elastic recovering force.

In addition, the main cover and the auxiliary cover may be made of a silicon material having an elastic recovering force.

The main cover may include: a vessel part having a predetermined space; a flange formed at an upper end of the vessel part to extend to an end of the opening formed at a front end of the ink outlet port; and a cover fitting part extending from the flange to be engaged with the auxiliary cover.

In addition, the vessel part may be provided with a third nozzle insertion port having a cross cut line for passing through the ink nozzle pipe at its bottom surface.

The auxiliary cover may be provided with a groove for fitting the cover fitting part.

In addition, the auxiliary cover may be provided with a straight type of fourth nozzle insertion port for passing through the ink nozzle pipe.

### [Advantageous Effects]

The present invention can block ink discharged from the ink storage pack when the print operation is completed to prevent unnecessary consumption of the ink.

In addition, the present invention can block the leakage of ink in the ink storage pack to prevent unnecessary consumption of the ink when an ink nozzle pipe is separated from a cover after the ink in the ink storage pack is discharged into a printer cartridge through the ink nozzle pipe.

### BEST MODE FOR CARRYING OUT THE INVENTION

The present invention will now be described more fully with reference to the accompanying drawings, in which preferred embodiments of the invention are shown.

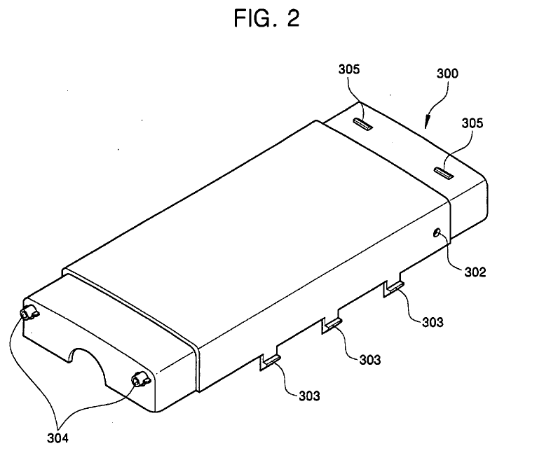

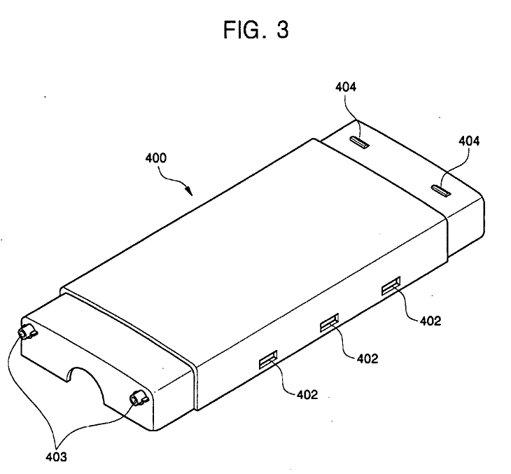

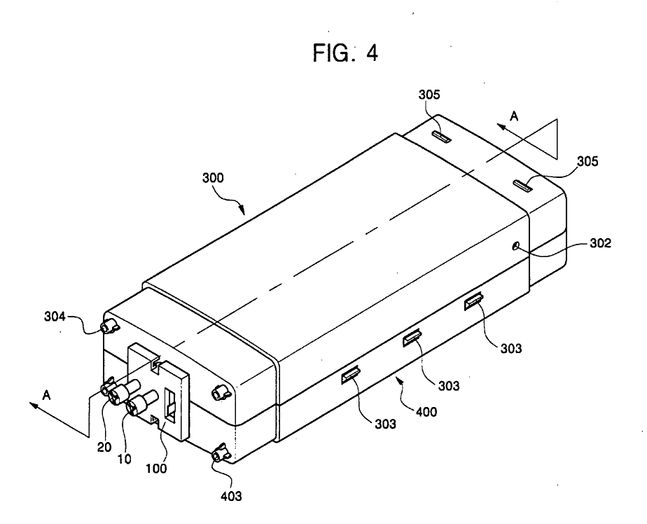

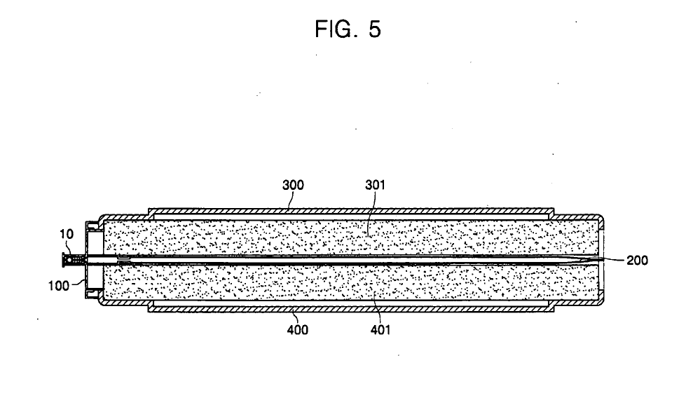

FIG. 2 is a perspective view of a first ink reservoir according to an embodiment of the present invention, FIG. 3 is a perspective view of a second ink reservoir according to an embodiment of the present invention, FIG. 4 is a perspective view of assembled first and second ink reservoirs, into which an ink storage pack and an expansion member are inserted, and FIG. 5 is a cross-sectional view taken along the line A-A in FIG. 4.

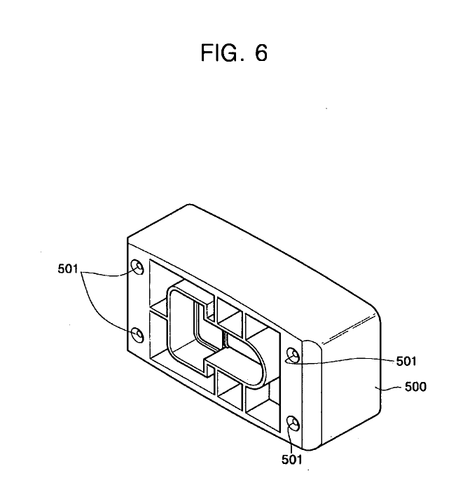

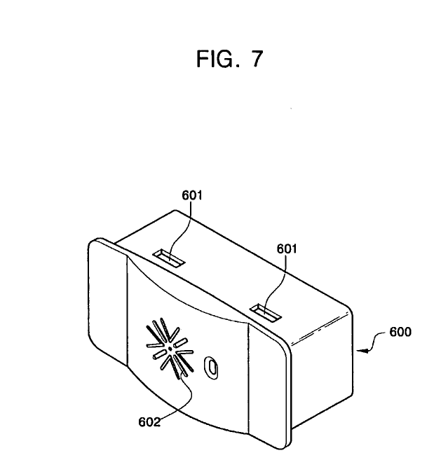

FIG. 6 is a perspective view of a front-end cover according to an embodiment of the present invention, FIG. 7 is a perspective view of a rear-end cover according to an embodiment of the present invention,

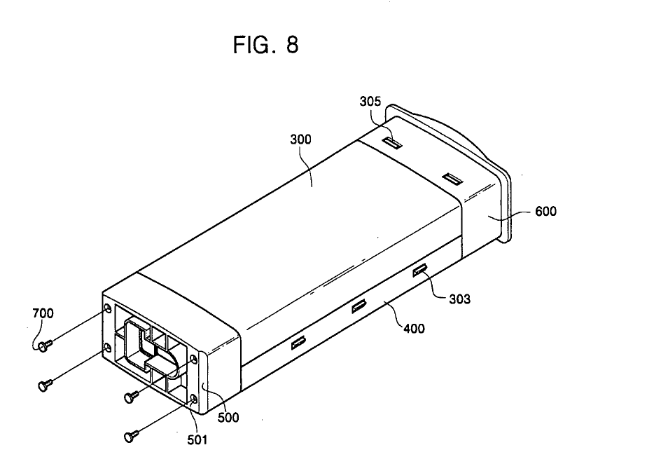

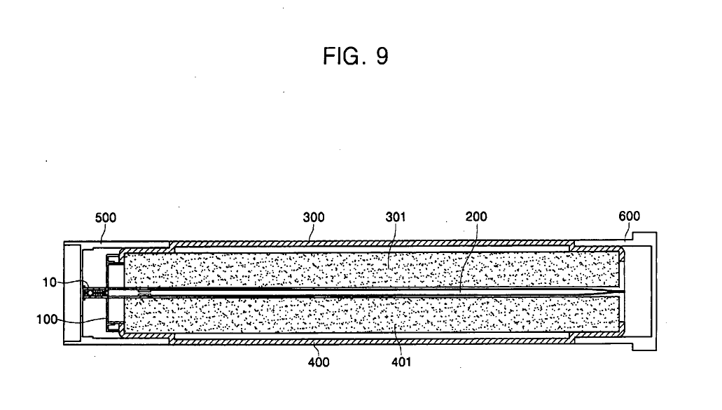

FIG. 8 is an assembled perspective view of an ink reservoir according to an embodiment of the present invention, and FIG. 9 is an assembled cross-sectional view of an ink reservoir according to an embodiment of the present invention.

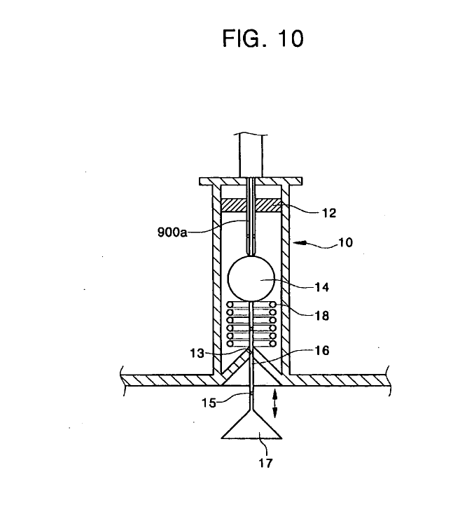

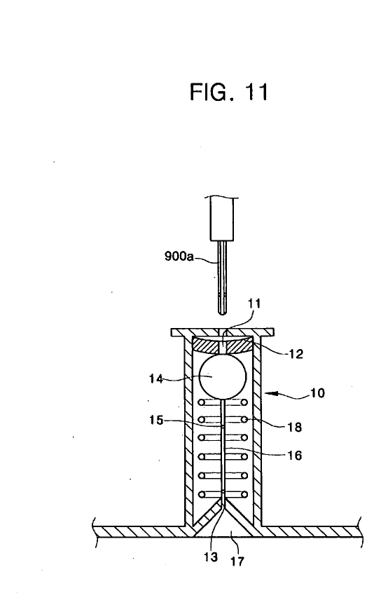

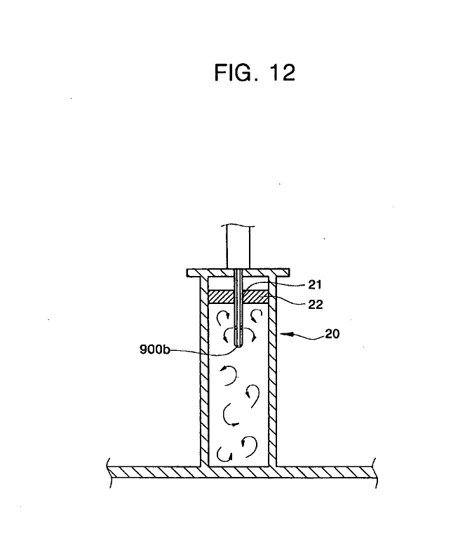

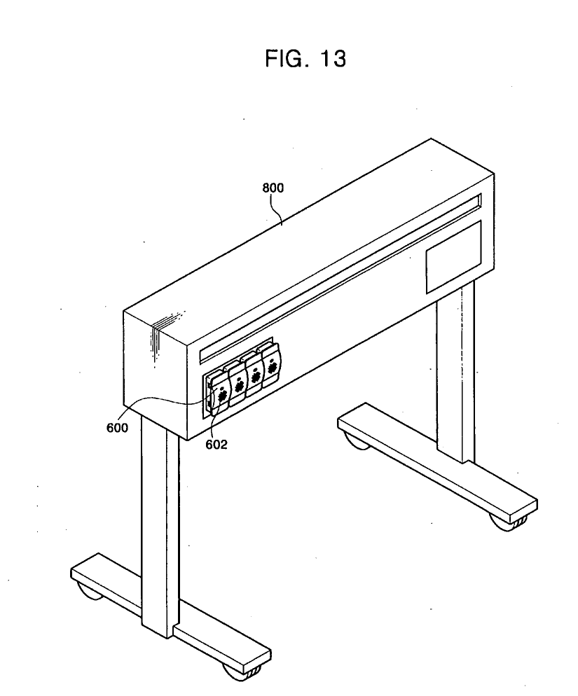

FIG. 10 is a cross-sectional view of an ink nozzle pipe inserted into an ink outlet port according to an embodiment of the present invention, FIG. 11 is a cross-sectional view of an ink nozzle pipe separated from an ink outlet port according to an embodiment of the present invention, FIG. 12 is a cross-sectional view of an ink nozzle pipe inserted into an air inlet port according to an embodiment of the present invention, and FIG. 13 is an assembled perspective view of an inkjet print system engaged with an ink reservoir according to an embodiment of the present invention.

As shown in FIGS. 2 to 13, an ink reservoir for an inkjet print system in accordance with an embodiment of the present invention includes a chassis member 100, an ink storage pack 200, first and second reservoir 300 and 400, a front-end cover 500, and a rear-end cover 600.

Referring to FIGS. 8 and 9, the chassis member 100 is engaged with openings formed at front ends of the first and second reservoirs 300 and 400, and includes an ink outlet port 10, an air inlet port 20 (see FIG. 4), and an ink level detection circuit (not shown).

Referring to FIGS. 10 and 11, the ink outlet port 10 includes: a first packing part 12 having a nozzle insertion port 11, and a first ink discharge port 13 in fluid communication with the ink storage pack 200 which are respectively formed at upper and lower ends thereof; and a dual safety device disposed between the first packing part 12 and the first ink discharge port 13 to control discharge of the ink in the ink storage pack 200.

At this time, the dual safety device includes a spherical member 14, a rod 16, a diaphragm 17, and a spring 18. The spherical member 14 is disposed under the first packing part 12 to be moved downward when an ink nozzle pipe 900a is inserted into the nozzle insertion port 11, and to be moved to its original position, i.e., upward to block the nozzle insertion port 11 due to a resilient force of the spring 18 when the ink nozzle pipe 900a is separated from the nozzle insertion port 11.

The rod 16 is integrally formed with the spherical member 14 and has a second ink discharge port 15 formed at its lower peripheral surface.

The diaphragm 17 is integrally formed with an end of the rod 13 to be disposed in the ink storage pack 200, and functions to open the first ink discharge port 13 of the ink outlet port 10 when the spherical member 14 is moved downward. Also, the diaphragm 17 functions to block the first ink discharge port 13 to prevent the discharge of the ink when the spherical member 14 is moved upward.

That is, in each component of the ink outlet port 10 in accordance with an embodiment of the present invention, when the ink nozzle pipe 900a is inserted into the first nozzle insertion port 11 of the ink outlet port 10 in order to discharge the ink stored in the ink storage pack 200 of the ink reservoir as shown in FIG. 10, the spherical member 14 which is in contact with an end of the ink nozzle pipe 900a is moved downward by the ink nozzle pipe 900a inserted as described above.

At this time, the rod 16 integrally formed with the spherical member 14 and the diaphragm 17 integrally formed with the rod 16 are moved downward together, the first ink discharge port 13 blocked by the diaphragm 17 is opened, at the same time, the ink stored in the ink storage pack 200 is guided into the ink outlet port 10 through the first ink discharge port 13 and the second ink discharge port 15 of the rod 16, and the ink flows along the peripheral surface of the spherical member 14 to be guided into the printer cartridge through a hole of the ink nozzle pipe 900a inserted into the first nozzle insertion port 11 of the first packing part 12.

Referring to FIGS. 11 and 12, an air nozzle pipe 900b is inserted into the air inlet port 20 when the ink reservoir is engaged with the inkjet print system, and the air inlet port 20 has a sealed space to prevent the air from being discharged to the exterior when the air insertion pipe 900b is inserted.

That is, as shown in FIG. 12, the air inlet port 20 includes a second packing part 22 formed at its inlet side, the second packing part 22 having a second nozzle insertion port 21 for blocking leakage of the air to the exterior, when the air nozzle pipe 900b is inserted into the sealed space to introduce the air into the space.

Referring to FIGS. 8 and 9, the ink storage pack 200 has a folded structure to store a predetermined amount of ink, and includes the ink level detection circuit engaged with the chassis member 100 and disposed at a peripheral surface of the ink storage pack 200.

At this time, a remaining amount of the ink in the ink storage pack 200 can be determined on the basis of information detected through the ink level detection circuit.

That is, while not shown, the ink level detection circuit includes an approximately flat spiral induction coil disposed on a side surface of the ink storage pack 200. The ink level detection circuit is connected to a conductive wire extending between the spiral induction coil and a contact pad accessible from the exterior, and the contact pad is exposed by each opening of an appropriate flexible board of the flexible circuit, which are electrically engaged with each other by an external contact element of the ink reservoir.

In addition, while not shown, the chassis member 100 employs a memory chip package including a memory access contact connected to a print controller when the ink reservoir is installed in the print system.

Referring to FIG. 2, a plurality of hooks 303 are formed at both ends of the first reservoir 300 to be assembled to the second reservoir 400, first fastening bosses 304 are formed at a front end of the first reservoir 300 to be assembled with the front-end cover 500, and first projections 305 are formed at a rear end of the first reservoir 300 to be assembled to the rear-end cover 600.

Referring to FIG. 3, a plurality of hook fastening holes 402 corresponding to the plurality of hooks 303 are formed at both ends of the second reservoir 400 to be assembled to the first reservoir 300, second fastening bosses 403 are formed at a front end of the second reservoir 400 to be assembled with the front-end cover 500, and second projections 404 are formed at a rear end of the second reservoir 400 to be assembled to the rear-end cover 600.

That is, the first and second reservoirs 300 and 400 can be assembled with each other to form a space for receiving the ink storage pack 200, and at this time, each opening is formed at the front and rear ends of the reservoirs 300 and 400 when the reservoirs 300 and 400 are completely assembled.

Referring to FIGS. 4 and 5, when the ink storage pack 200 is received into the space formed by the assembly of the first and second reservoirs 300 and 400, expansion members 301 and 401 are in contact with the ink storage pack 200 to discharge the, ink, and are disposed at the first and second reservoirs 300 and 400, respectively.

At this time, the expansion members 301 and 401 may be formed of a synthetic foam material such as a sponge with open cells and sufficient flexibility and elasticity, or formed of a leaf spring having sufficient flexibility and elasticity.

In addition, in order to naturally discharge the ink stored in the ink storage pack 200 using the synthetic foam material such as a sponge or a leaf spring, an air hole 302 is formed at one end of the first or second reservoir 300 or 400 to cause the assembled reservoirs 300 and 400 not to be hermitically sealed with each other.

Referring to FIGS. 6 and 8, the front-end cover 500 is fastened to the first and second fastening bosses 304 and 403 formed at the front end of the assembled first and second reservoirs 300 and 400 by a plurality of fastening members such as bolts 700 passing through a plurality of fastening holes 501.

Referring to FIG. 7, the rear-end cover 600 is fitted into the rear end of the assembled first and second reservoirs 300 and 400, and includes a plurality of fastening holes 601 for fitting.

That is, when the rear-end cover 600 is engaged with the rear end of the assembled first and second reservoirs 300 and 400, the first and second projections 305 and 404 formed at the first and second reservoirs 300 and 400 are inserted and fitted into the fastening holes 601 so that the first and second reservoirs 300 and 400 are securely assembled with the rear-end cover 600.

At this time, the rear-end cover 600 has a see-through hole 602 for visually checking variations of volume of the ink storage pack 200 when the ink storage pack 200 is received in the space formed between the first and second reservoirs 300 and 400, and the see-through hole 602 may be formed as various embodiments depending on its use environment.

Hereinafter, an operation of the first embodiment in accordance with the present invention will be described in conjunction with FIGS. 2 to 13.

First, as shown in FIG. 13, when the assembled ink reservoir of the present invention is engaged with an ink supply station of the inkjet print system 800, an operator can visually check variations of volume of ink in the ink storage pack 200 through the rear-end cover 600 assembled with the rear end of the ink reservoir.

When the ink reservoir is engaged with the ink supply station of the inkjet print system 800, the ink nozzle pipe 900a and the air nozzle pipe 900b are inserted into the ink outlet port 10 and the air inlet port 20 of the chassis member 100 protected by the front-end cover 500 engaged with the front end of the first and second reservoirs 300 and 400 forming the ink reservoir.

Then, when the air is introduced into the air inlet port 20 through which the air nozzle pipe 900b is inserted, the introduced air does not leak from the air inlet port 20 by the second packing part 22, and at the same time, a predetermined level of air pressure is applied into the air inlet port 20 to prevent additional injection of the air.

Meanwhile, when the ink nozzle pipe 900a is inserted into the ink outlet port 10, the end of the ink nozzle pipe 900a pushes the spherical member 14 downward as shown in FIG. 10.

As a result, the rod 16 integrally formed with the spherical member 14 and the diaphragm 17 integrally formed with the end of the rod 16 are moved downward.

The first ink discharge port 13 blocked by the diaphragm 17 is opened, and at the same time, the ink stored in the ink storage pack 200 is guided into the ink outlet port 10 through the opened first ink discharge port 13 and the opened second ink discharge port 15 of the rod 16 by natural expansion of the expansion members 301 and 401 installed in the first and second reservoirs 300 and 400.

Then, the ink guided into the ink outlet port 10 flows along the peripheral surface of the spherical member 14 to be guided into the hole of the ink nozzle pipe 900a inserted into the first nozzle insertion port 11 of the first packing part 12.

At this time, since the ink nozzle pipe 900a is connected to the print cartridge through a tube, the ink introduced into the ink nozzle pipe 900a can be supplied into the print cartridge to perform a printing operation.

In this process, when the ink reservoir is separated from the inkjet print system 800, the ink nozzle pipe 900a and the air nozzle pipe 900b are separated from the ink outlet port 10 and the air inlet port 20, and simultaneously, it is prevented the ink in the ink storage pack 200 from being discharged through the ink outlet port 10.

That is, when the ink nozzle pipe 900a is separated from the ink outlet port 10, the spherical member 14 moved downward by the ink nozzle pipe 900a is moved to its original position, i.e., upward by resilient force of the spring 18 to block the first nozzle insertion port 11 of the first packing part 12.

Concurrently, the diaphragm 17 connected to the spherical member 14 through the rod 16 and disposed in the ink storage pack 200 is also moved upward to block the second ink discharge port 15. Therefore, it is possible to prevent the ink in the ink storage pack 200 from discharging since the spherical member 14 and the diaphragm 17 simultaneously blocks the first and second ink discharge ports 13 and 15.

Meanwhile, as described above, when the ink in the ink storage pack 200 is depleted due to the printing operation, the ink storage pack 200 can be separated from the first and second reservoirs 300 and 400 to recharge the ink.

That is, the first and second reservoirs 300 and 400, and the front-end and rear-end covers 500 and 600 engaged with the front and rear ends of the first and second reservoirs 300 and 400 are detachably engaged with each other. Therefore, after the front-end and rear-end covers 500 and 600 are separated from the first and second reservoirs 300 and 400, when the first and second reservoirs 300 and 400 are separated from each other, it is possible to draw out the ink storage pack 200 disposed in the first and second reservoirs 300 and 400 to refill the ink or to replace with a new ink storage pack.

### [Another Mode for Carrying out the Invention]

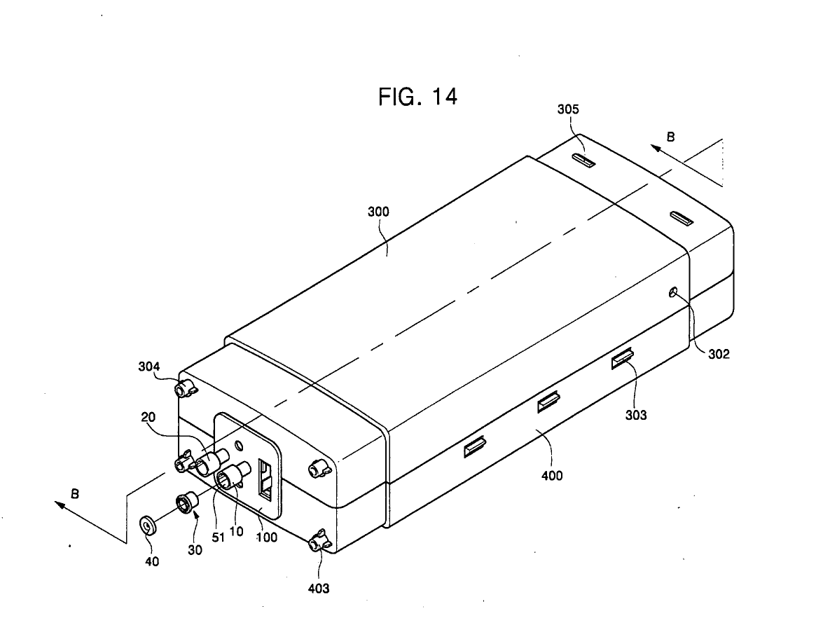

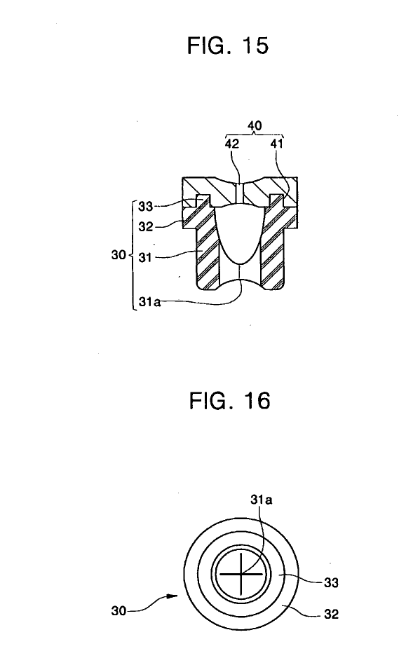

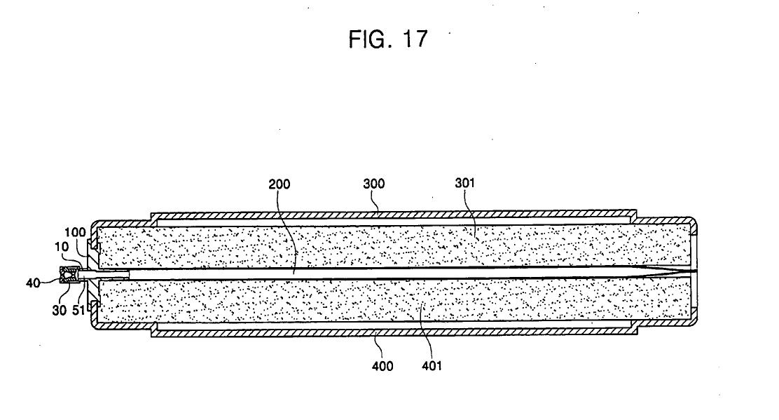

FIGS. 14 to 19 illustrate another embodiment of a cover of an ink outlet port 10.

That is, as shown in FIGS. 14 to 19, an inkjet print system in accordance with another embodiment of the present invention includes: an ink storage pack 200; a chassis member including an ink outlet port 10, an air inlet port 20, and an ink level detection circuit (not shown); an ink nozzle pipe 900a, a printer cartridge (not shown), and a dual cover including a main cover 30 and an auxiliary cover 40.

Here, an opening 51 is formed at a front end of the ink outlet port 10 to engage the main cover 30 and the auxiliary cover 40 with each other.

The main cover 30 functions to prevent ink from leaking when the ink nozzle pipe 900a is separated from the ink outlet port 10. The main cover 30 is readily fitted into the ink outlet port 10 from the opening 51, and made of a rubber or silicon material, preferably the rubber material, having an elastic recovering force for preventing ink leakage.

In this process, the main cover 30 includes a vessel part 31, a flange 32, and a cover fitting part 33. The vessel part 31 providing a predetermined space for discharging ink is fitted into the ink outlet port 10. A third nozzle insertion port 31 a having a cross cut line for passing through the ink nozzle pipe 900a is formed at a bottom surface of the vessel part 31.

The cross cut line is deformed in a separating direction of the ink outlet port 10 when the ink nozzle pipe 900a is separated from the ink outlet port 10, and on the contrary, deformed in the penetrating direction when the ink nozzle pipe 900a penetrates the third nozzle insertion port 31a, thereby preventing the ink in the ink storage pack 200 from leaking to the exterior.

The flange 32 disposed at an upper end of the vessel part 31 extends to a distal end of the opening 51 formed at the front end of the ink outlet port 10.

The cover fitting part 33 extends from the flange 32 to be engaged with the auxiliary cover 40.

The auxiliary cover 40 functions to seal the vessel part 31 of the main cover 30, and includes a groove 41 for fitting the cover fitting part 33 and a straight type of fourth nozzle insertion port 42 for passing through the ink nozzle pipe 900a. Therefore, the auxiliary cover 40 formed of a rubber or silicon material having an elastic recovering force for preventing ink leakage can be readily fitted to the main cover 30.

Hereinafter, an operation of another embodiment in accordance with the present invention will be described in conjunction with FIGS. 14 to 19.

First, the opening 51 is formed at the ink outlet port 10 of the chassis member 100 engaged with the front end of the ink storage pack 200, and the vessel part 31 of the main cover 30 is inserted into the ink outlet port 10 through the opening 51.

Then, the flange 32 integrally formed with the vessel part 31 is hooked by the opening 51, and at the same time, a bottom surface of the vessel part 31 functions as one partition in the ink outlet port 10.

Then, the auxiliary cover 40 is fitted onto the vessel part 31.

That is, since the vessel part 31 has the cover fitting part 33 and the auxiliary cover 40 has the groove 41, when the auxiliary cover 40 and the main cover 30 are engaged with each other, the cover fitting part 33 is fitted into the groove 41 to complete the engagement of the main cover 30 and the auxiliary cover 40.

Meanwhile, after the completion of engagement of the main cover 30 and the auxiliary cover 40 of the dual cover with the ink outlet port 10, the ink reservoirs 300 and 400 containing the ink storage pack 200 are mounted in the inkjet print system 800 of FIG. 13.

Then, the ink nozzle pipe 900a connected to the print cartridge through the tube is inserted into the ink outlet port 10 of the chassis member 100 engaged with the front end of the ink storage pack 200.

That is, after the end of the ink nozzle pipe 900a passes through the fourth nozzle insertion port 42 formed at the auxiliary cover 40, and continuously, the ink nozzle pipe 900a passes through the third nozzle insertion port 31a formed at the bottom surface of the vessel part 31 of the main cover 30, thereby being inserted into the ink storage pack 200.

As a result, the ink in the ink storage pack 200 can be supplied into the print cartridge through the tube.

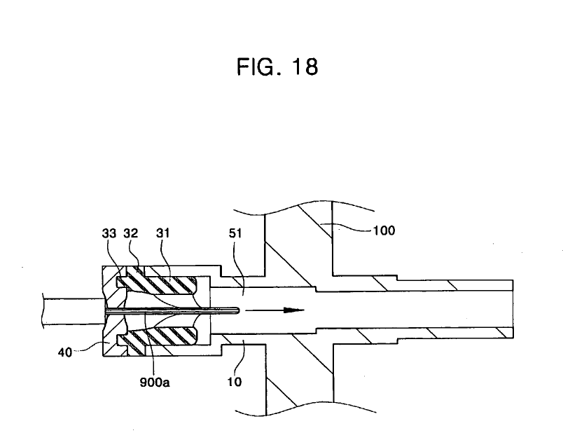

In this process, when the ink nozzle pipe 900a passes through the third nozzle insertion port 31a, as shown in FIG. 18, the cross cut line formed at the third nozzle insertion port 31 a is deformed in the penetrating direction of the ink nozzle pipe 900a in the state that the cross cut line is stuck to the peripheral surface of the ink nozzle pipe 900a.

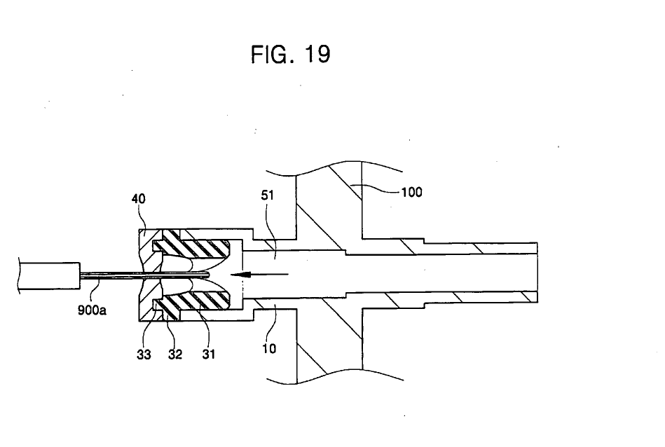

Meanwhile, when the ink nozzle pipe 900a is separated from the ink outlet port 10, as shown in FIG. 19, after the cross cut line is deformed in the separating direction of the ink nozzle pipe 900a in the state that the cross cut line is stuck to the peripheral surface of the ink nozzle pipe 900a, the cross cut line is returned to its original shape from the entire separation of the ink nozzle pipe 900a, and the fourth nozzle insertion port 42 of the auxiliary cover 40 is shrunk when the ink nozzle pipe is separated. Therefore, it is possible to prevent the ink stored in the ink storage pack 200 from leaking to the exterior through the ink outlet port 10 using the dual cover including the main cover 30 and the auxiliary cover 40.

1. An ink reservoir for an inkjet print system, comprising:
a chassis member including an ink outlet port, an air inlet port, and an ink level detection circuit;
an ink storage pack hermetically connected to a front end of the chassis member to store a predetermined amount of ink;
first and second reservoirs having upper and lower openings, and assembled together to form a space for receiving the ink storage pack;
a front-end cover assembled at front ends of the first and second reservoirs by a fastening member when the reservoirs are assembled together; and
a rear-end cover engaged with rear ends of the first and second reservoirs in a fitting manner when the reservoirs are assembled together.

2. The ink reservoir according to claim 1, wherein the ink storage pack is naturally shrunk by expansion of expansion members respectively received in the first and second reservoirs.

3. The ink reservoir according to claim 2, wherein the expansion member is formed of a synthetic foam material with open cells and sufficient flexibility and elasticity.

4. The ink reservoir according to claim 2, wherein the expansion member is formed of a leaf spring having sufficient flexibility and elasticity.

5. The ink reservoir according to claim 1, wherein one of the first and second reservoirs has an air hole for introducing an exterior air into the reservoirs to cause the space between the reservoirs not to be hermetically sealed when the ink storage pack is received in the reservoirs.

6. The ink reservoir according to claim 1, wherein the first reservoir comprises;
a plurality of hooks formed at both sides thereof to be assembled with the second reservoir;
a first fastening boss formed at a front end thereof to be assembled with the front-end cover; and
a first projection formed at a rear end thereof to be assembled with the rear-end cover.

7. The ink reservoir according to claim 1, wherein the second reservoir comprises:
a plurality of fastening holes corresponding to hooks and formed at both sides thereof to be assembled with the first reservoir;
a second fastening boss formed at a front end thereof to be assembled with the front-end cover; and
a second projection formed at a rear end thereof to be assembled with the rear-end cover.

8. The ink reservoir according to claim 6, wherein the front-end cover has fastening holes for passing through a plurality of fastening members to be fastened to the first fastening boss.

9. The ink reservoir according to claim 7, wherein the front-end cover has fastening holes for passing through a plurality of fastening members to be fastened to the second fastening boss.

10. The ink reservoir according to claim 1, wherein the rear-end cover comprises:
hooking holes for hooking first and second projections formed at the rear ends of the first and second reservoirs; and
a see-through hole for visually checking variations of volume of the ink storage pack received in the space provided between the assembled first and second reservoirs.

11. The ink reservoir according to claim 1, wherein the ink outlet port comprises:
a first packing part having a nozzle insertion port and a first ink discharge port in fluid communication with the ink storage pack, the first packing part and the first ink discharge port being respectively formed at upper and lower ends of the ink outlet port; and
a dual safety device installed between the first packing part and the first ink discharge port to control the discharge of the ink in the ink storage pack depending on whether an ink nozzle pipe is inserted into the nozzle insertion port.

12. The ink reservoir according to claim 11, wherein the dual safety device comprises:
a spherical member disposed under the first packing part to be movable downward when the ink nozzle pipe is inserted into the nozzle insertion port;
a rod integrally formed with the spherical member and having a second ink discharge port formed at a peripheral surface of a lower end thereof;
a diaphragm integrally formed with an end of the rod to control the discharge of the ink by opening/closing the first ink discharge port of the ink outlet port by movement of the spherical member; and
a spring inserted onto the rod to return the spherical member to its original position when the ink nozzle pipe is separated from the nozzle insertion port.

13. The ink reservoir according to claim 1, wherein the air inlet port comprises a second packing part having a second nozzle insertion port for blocking air leaked to the exterior when an air nozzle pipe is inserted into a sealed space to allow the air to be introduced into the sealed space.

14. An ink reservoir for an inkjet print system, comprising:
a chassis member including an ink outlet port, an air inlet port, and an ink level detection circuit;
an ink storage pack hermetically connected to a front end of the chassis member to store a predetermined amount of ink;
first and second reservoirs having upper and lower openings and assembled together to form a space for receiving the ink storage pack;
a front-end cover assembled at front ends of the first and second reservoirs by a fastening member when the reservoirs are assembled together;
a rear-end cover engaged with rear ends of the first and second reservoirs in a fitting manner when the reservoirs are assembled together; and a dual cover engaged with an opening formed at a front end of the ink outlet port.

15. The ink reservoir according to claim 14, wherein the dual cover comprises a main cover fitted into the ink outlet port through the opening to prevent leakage of ink; and an auxiliary cover for sealing the opening of the ink outlet port.

16. The ink reservoir according to claim 15, wherein the main cover is made of a rubber material having an elastic recovering force.

17. The ink reservoir according to claim 15, wherein the main cover is made of a silicon material having an elastic recovering force.

18. The ink reservoir according to claim 15, wherein the auxiliary cover is made of a rubber material having an elastic recovering force.

19. The ink reservoir according to claim 15, wherein the auxiliary cover is made of a silicon material having an elastic recovering force.

20. The ink reservoir according to claim 15, wherein the main cover comprises: a vessel part having a predetermined space; a flange formed at an upper end of the vessel part to extend to an end of the opening formed at a front end of the ink outlet port; and a cover fitting part extending from the flange to be engaged with the auxiliary cover.

21. The ink reservoir according to claim 20, wherein the vessel part is provided with a third nozzle insertion port having a cross cut line for passing through the ink nozzle pipe at its bottom surface.

22. The ink reservoir according to claim 20, wherein the auxiliary cover is provided with a groove for fitting the cover fitting part.

23. The ink reservoir according to claim 15, wherein the auxiliary cover is provided with a straight type of fourth nozzle insertion port for passing through the ink nozzle pipe.
